(19) United States
(12) Patent Application Publication
(10) Pub. No.: US 2026/0213564 A1
(43) Pub. Date: Jul. 23, 2026

(54) CHARGING AND DISCHARGING APPARATUS AND CONTROL METHOD THEREOF

(71) Applicant: SK On Co., Ltd., Seoul (KR)

(72) Inventors: Woo Seop KIM, Daejeon (KR); Jung Hak YOON, Daejeon (KR); Byung Wook KIM, Daejeon (KR); Yu Gyung KIM, Daejeon (KR); Jung Uk KIM, Daejeon (KR); Kwae Ha KIM, Daejeon (KR); Ji Won HONG, Daejeon (KR)

(21) Appl. No.: 19/454,386

(22) Filed: Jan. 21, 2026

(30) Foreign Application Priority Data
Jan. 21, 2025 (KR) 10-2025-0008809

(51) Int. Cl. H02J 7/90; H01M 10/44; H02J 7/70; H02J 7/80

(52) U.S. Cl. CPC H02J 7/975; H01M 10/443; H02J 7/70; H02J 7/80

(57) ABSTRACT

The present disclosure relates to a charging and discharging apparatus and a control method thereof, the charging and discharging apparatus including: a jig for supporting a battery cell; a temperature sensor disposed at one side of the jig and configured to measure a temperature of the battery cell or a temperature of a region adjacent to the battery cell; a charging and discharging channel electrically connected to the battery cell; and a control unit configured to control a voltage and a current of the battery cell through the charging and discharging channel to charge or discharge the battery cell and to calculate an electric capacity of the battery cell.

### CROSS-REFERENCE TO RELATED PATENT APPLICATION

The present application claims priority under 35 U.S.C. § 119(a) to Korean patent application number 10-2025-0008809 filed on January 21, 2025, in the Korean Intellectual Property Office, the entire disclosure of which is incorporated by reference herein.

### BACKGROUND OF THE INVENTION

### 1. Field

The present disclosure relates to a charging and discharging apparatus and a control method thereof, and more particularly, to a charging and discharging apparatus and a control method thereof for improving the efficiency of a battery manufacturing process.

### 2. Description of the Related Art

A charging and discharging apparatus performs a function of imparting characteristics to a battery cell by repeatedly performing a charging and discharging process several times so that a first battery cell (or a secondary battery), in which assembly is completed during a battery cell production process, can store electrical energy.

In the charging and discharging apparatus, a battery cell may exhibit a deviation in charging capacity depending on an environment (for example, temperature) of the battery cell. In particular, a conventional charging and discharging apparatus calculates a charging capacity (or electric capacity) of a battery cell charged through a charging and discharging channel using a single correction formula, and thus, a calculated charging capacity of a battery cell charged or discharged at various temperatures may differ from an actual measured capacity. Therefore, there is a need for a correction method capable of more accurately reflecting the charging capacity of a battery cell at various temperatures.

### SUMMARY OF THE INVENTION

First, according to one aspect of the present disclosure, an object to be achieved is to improve the efficiency of a battery manufacturing process.

Second, according to another aspect of the present disclosure, an object to be achieved is to reduce a defect rate of a battery cell.

Third, according to still another aspect of the present disclosure, an object to be achieved is to improve the quality of a battery cell.

Meanwhile, the charging and discharging apparatus according to the present disclosure can be widely applied to green technology fields such as electric vehicles (EVs), battery charging stations, energy storage systems (ESS), photovoltaics, and wind power using batteries. In addition, the charging and discharging apparatus according to the present disclosure can be used in eco-friendly mobility, including electric vehicles and hybrid vehicles, for preventing climate change by suppressing air pollution and greenhouse gas emissions.

As a technical means to achieve the technical objects, a charging and discharging apparatus according to the present disclosure may comprise: a jig for supporting a battery cell; a temperature sensor disposed at one side of the jig and configured to measure a temperature of the battery cell or a temperature of a region adjacent to the battery cell; a charging and discharging channel electrically connected to the battery cell; and a control unit configured to control a voltage and a current of the battery cell through the charging and discharging channel to charge or discharge the battery cell and to calculate an electric capacity of the battery cell, wherein the control unit may divide a charging process or a discharging process of the battery cell into at least one sub-section, set a representative temperature among temperatures measured by the temperature sensor for each of the at least one sub-section, and correct the electric capacity based on the representative temperature.

According to one embodiment, the control unit may set the representative temperature based on a difference between a corrected electric capacity according to each of the measured temperatures within the at least one sub-section and an actual electric capacity of the battery cell.

According to one embodiment, the control unit may calculate a time point at which a difference between the corrected electric capacity and the actual electric capacity within the at least one sub-section has a minimum value, and set a temperature at the time point as the representative temperature.

According to one embodiment, the charging and discharging channel may apply a current to the battery cell until the battery cell reaches a preset target voltage.

According to one embodiment, the control unit may control a current applied through the charging and discharging channel to have at least one of a preset constant input current and a preset constant input voltage.

According to one embodiment, the control unit may calculate the corrected electric capacity based on the current, the target voltage, and the measured temperature.

According to one embodiment, the temperature sensor may measure the temperature a plurality of times within the at least one sub-section.

According to one embodiment, the control unit may update the representative temperature for each of the at least one sub-section.

According to one embodiment, the control unit may charge or discharge the battery cell based on the corrected electric capacity calculated based on the representative temperature.

As a technical means to achieve the technical objects, a control method of a charging and discharging apparatus according to the present disclosure may be a control method of a charging and discharging apparatus including a charging and discharging channel electrically connected to a battery cell and a jig supporting the battery cell, and may comprise: charging or discharging the battery cell by controlling a voltage and a current of the battery cell through the charging and discharging channel; measuring a temperature of the battery cell or a temperature of a region adjacent to the battery cell through a temperature sensor disposed at one side of the jig; calculating an electric capacity of the battery cell; and correcting the electric capacity based on a representative temperature, wherein the representative temperature is set among temperatures measured by the temperature sensor for each of at least one sub-section obtained by dividing a charging process or a discharging process of the battery cell.

According to one embodiment, correcting the electric capacity may include setting a representative temperature based on a difference between a corrected electric capacity according to each of the measured temperatures within the at least one sub-section and an actual electric capacity of the battery cell.

According to one embodiment, correcting the electric capacity may include calculating a time point at which a difference between the corrected electric capacity and the actual electric capacity within the at least one sub-section has a minimum value, and setting a temperature at the time point as the representative temperature.

According to one embodiment, charging or discharging the battery cell may include applying a current to the battery cell through the charging and discharging channel until the battery cell reaches a preset target voltage.

According to one embodiment, measuring the temperature may include measuring the temperature a plurality of times within the at least one sub-section.

According to one embodiment, after correcting the electric capacity, the method may further include charging or discharging the battery cell according to the corrected electric capacity based on the representative temperature.

First, according to one embodiment of the present disclosure, the efficiency of a battery manufacturing process can be improved.

Second, according to another embodiment of the present disclosure, a defect rate of a battery cell can be reduced.

Third, according to still another embodiment of the present disclosure, the quality of a battery cell can be improved.

### BRIEF DESCRIPTION OF THE DRAWINGS

FIG. 1 is a view illustrating an example of a charging and discharging apparatus according to the present disclosure.

FIG. 2 is a view illustrating a side view example of a jig of the charging and discharging apparatus shown in FIG. 1.

FIG. 3 is a block diagram illustrating an example of a configuration of the charging and discharging apparatus according to the present disclosure.

FIGS. 4 and 5 are flowcharts illustrating an example of a control method of the charging and discharging apparatus according to the present disclosure.

FIG. 6 is a view for explaining an example of measuring a temperature during a charging process of the charging and discharging apparatus according to the present disclosure.

FIGS. 7 and 8 are views for explaining an example of setting a representative temperature during a process of calculating an electric capacity of the charging and discharging apparatus according to the present disclosure.

### DETAILED DESCRIPTION

Hereinafter, preferred embodiments of the present disclosure will be described in detail with reference to the accompanying drawings. The configuration of the apparatus or the control method described below is merely for illustrating embodiments of the present disclosure and is not intended to limit the scope of the present disclosure, and like reference numerals used throughout the specification denote like elements.

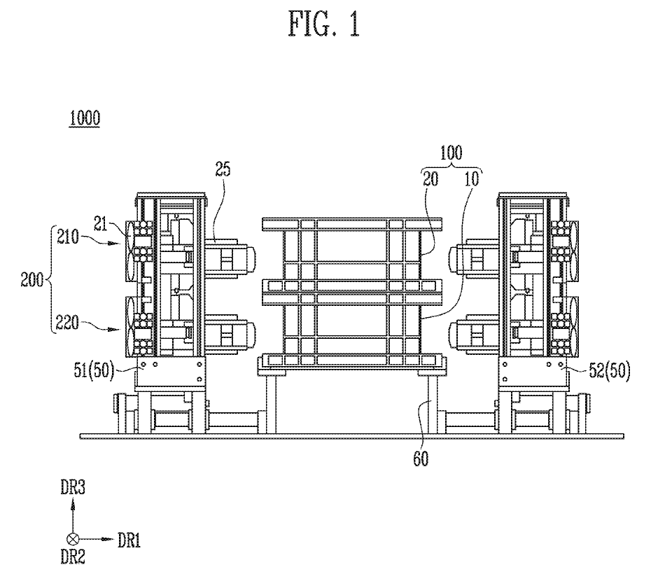

FIG. 1 is a view illustrating an example of a charging and discharging apparatus according to the present disclosure.

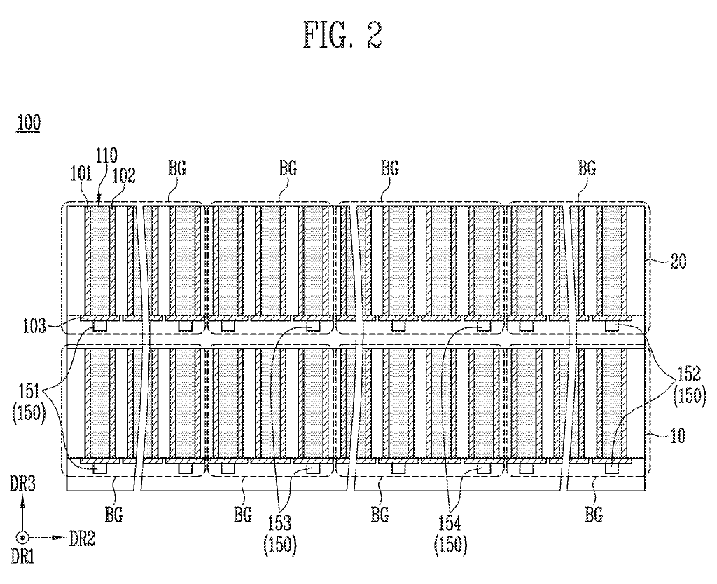

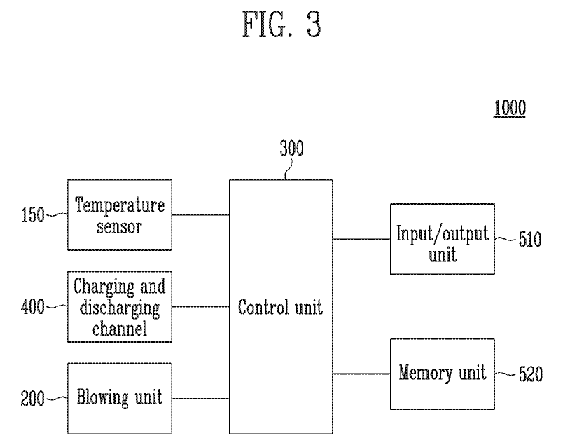

Referring to FIG. 1, a charging and discharging apparatus 1000 may include a jig 100 for supporting a battery cell 110 (see FIG. 2) and a charging and discharging channel 400 (see FIG. 3) electrically connected to the battery cell 110. In addition, the charging and discharging apparatus 1000 may further include a blowing unit 200 configured to blow external air toward the battery cell 110 with the battery cell 110 interposed therebetween.

The charging and discharging apparatus 1000 may refer to a charging and discharging apparatus of a battery cell that charges and discharges the battery cell 110 in an online process or an offline process of the battery cell 110.

The jig 100 may accommodate the battery cell 110. Referring to FIG. 1, for example, the jig 100 may be stacked along a height direction (for example, a third direction DR3) of the charging and discharging apparatus 1000. For example, the jig 100 may include a first jig 10 and a second jig 20, each accommodating the battery cell 110. The second jig 20 may be disposed on an upper side of the first jig 10. However, this is merely an example, and the number of stacked jigs 100 may be variously modified.

The jig 100 may be supported by a support portion 60.

The blowing unit 200 may suction external air and blow it toward the battery cell 110. The blowing unit 200 may be disposed along a width direction (for example, a first direction DR1) of the charging and discharging apparatus 1000 with the jig 100 interposed therebetween.

The blowing unit 200 may suction external air and blow it toward each end of the jig 100. For example, the blowing unit 200 may include a plurality of blowing units, and the plurality of blowing units 200 may include a first blowing unit 210 configured to blow external air toward the first jig 10, and a second blowing unit 220 configured to blow external air toward the second jig 20.

The blowing unit 200 may include a motor (not shown) for generating rotational force, a blowing fan 21 connected to a rotation shaft of the motor, and a blowing duct 25 configured to transfer the external air suctioned through the blowing fan 21 toward the battery cell 110.

A central portion of the blowing fan 21 may be coupled to the rotation shaft of the motor. A control unit 300 (see FIG. 3), which will be described later, may control an air volume of the blowing unit 200.

The charging and discharging apparatus 1000 may further include a blowing frame 50 that supports the blowing unit 200. Since the blowing unit 200 is disposed with the jig 100 interposed therebetween, the blowing frame 50 may include a first blowing frame 51 located on a left side of the jig 100 (for example, in a direction opposite to the first direction DR1) and a second blowing frame 52 located on a right side of the jig 100 (for example, in the first direction DR1).

FIG. 2 is a view illustrating a side view example of a jig of the charging and discharging apparatus shown in FIG. 1.

Referring to FIG. 2, the charging and discharging apparatus 1000 may include a temperature sensor 150 disposed at one side of the jig 100. The temperature sensor 150 may measure a temperature of the battery cell 110 or a temperature of a region adjacent to the battery cell 110. The jig 100 may include a plurality of jigs 10 and 20 stacked along a height direction (for example, a third direction DR3) of the charging and discharging apparatus 1000. For example, the plurality of jigs 10 and 20 may respectively accommodate a plurality of battery groups BG in which adjacent battery cells 110 among the plurality of battery cells 110 are grouped. The plurality of jigs 10 and 20 may each include sub-jigs 101 to 103. For example, the battery cell 110 may be disposed between a first sub-jig 101 and a second sub-jig 102. The battery cell 110 may be disposed on one surface of a third sub-jig 103 connecting the first and second sub-jigs 101 and 102. The plurality of battery groups BG may each be placed on a tray (not shown) and accommodated in the jig 100. In addition, the plurality of jigs 10 and 20 may be electrically connected to the battery groups BG accommodated in the trays.

The temperature sensor 150 may be provided as a plurality of sensors. For example, the plurality of temperature sensors 150 may include a first temperature sensor 151, a second temperature sensor 152, a third temperature sensor 153, and a fourth temperature sensor 154, which are disposed to correspond to a plurality of battery groups BG.

The temperature sensors 150 may be disposed at one side of the plurality of jigs 10 and 20 to measure a temperature of regions adjacent to the plurality of battery groups BG. Each of the plurality of jigs 10 and 20 may include four battery groups BG, and the plurality of temperature sensors 151, 152, 153, and 154 may be disposed to correspond to each of the battery groups BG. Therefore, each battery group BG may correspond to at least one temperature sensor 150.

Referring to FIG. 2, the temperature sensor 150 may be disposed on one of the surfaces of the third sub-jig 103. The battery cell 110 is in contact with one surface of the third sub-jig 103, and the temperature sensor 150 may be attached to the other surface opposite to the one surface of the third sub-jig 103. For example, when a lower surface of the battery cell 110 is in contact with one surface of the third sub-jig 103, heat generated from the battery cell 110 may be conducted through the third sub-jig 103. The temperature sensor 150 is attached to the other surface of the third sub-jig 103 to detect the heat conducted from the lower surface of the battery cell 110, and the temperature of the battery cell 110 may be measured based thereon. The temperature sensor 150 may be disposed on the other surface of the third sub-jig 103, which is a region adjacent to the battery cell 110 along a heat conduction path between the battery cell 110 and the third sub-jig 103, where heat generated from the battery cell 110 is transferred. However, this is merely an example, and the position of at least one temperature sensor 150 is not limited thereto.

For example, the temperature sensor 150 may be directly disposed on one of the surfaces of the battery cell 110. In this case, a temperature change can be detected early before the heat of the battery cell 110 is transferred to the third sub-jig 103. In another example, the temperature sensor 150 may be disposed in a spaced region between the battery cell 110 and the first and second sub-jigs 101 and 102. In this case, instead of directly detecting the temperature of the battery cell 110, an overall thermal state can be detected along a heat diffusion path.

FIG. 3 is a block diagram illustrating an example of a configuration of the charging and discharging apparatus according to the present disclosure.

Referring to FIG. 3, the charging and discharging apparatus 1000 may include a temperature sensor 150, a charging and discharging channel 400, a blowing unit 200, a control unit 300, an input/output unit 510, and a memory unit 520.

The control unit 300 may control a voltage and a current of the battery cell 110 (see FIG. 2) through the charging and discharging channel 400 to charge or discharge the battery cell 110.

The control unit 300 may charge or discharge the battery cell 110 supported by the jig 100 (see FIG. 1) through the charging and discharging channel 400. The charging and discharging channel 400 may apply a current to the battery cell 110 until the battery cell 110 reaches a preset target voltage. The charging and discharging channel 400 may be provided as a plurality of channels and may apply a current to a plurality of battery groups BG grouped by a preset number among a plurality of battery cells 110. That is, the control unit 300 may charge or discharge a plurality of battery groups BG, each electrically connected to a plurality of charging and discharging channels 400, through the plurality of charging and discharging channels 400.

The control unit 300 may control a current applied through the charging and discharging channel 400 to have at least one of a preset constant input current and a preset constant input voltage. For example, during an initial charging process, the control unit 300 may control the system to apply a constant input current, thereby increasing a voltage of the battery cell 110. In this case, the applied input current is maintained at a constant level, and the voltage of the battery cell 110 may gradually increase. In addition, after the initial charging process, when the voltage of the battery cell 110 reaches a preset reference voltage, the control unit 300 may control the system to apply a current at a constant input voltage. In this case, after the battery cell 110 reaches the reference voltage, the applied input voltage is maintained at a constant level, and the input current gradually decreases, thereby allowing current to be applied until the battery cell 110 is fully charged.

The control unit 300 may calculate an electric capacity (or charging capacity) of the battery cell 110. The control unit 300 may calculate the electric capacity (or charging capacity) of the battery cell 110 through the charging and discharging channel 400 and determine whether charging or discharging of the battery cell 110 has been completed. For example, when the battery cell 110 is charged with a constant input current, the control unit 300 may calculate the electric capacity of the battery cell 110 based on a charging time. However, this is merely an example, and the electric capacity of the battery cell 110 may be calculated by various known methods. Here, the electric capacity of the battery cell 110 may refer to a maximum electric capacity stored in the battery cell 110 when a state of charge (SOC) of the battery cell 110 reaches 100%. When the control unit 300 determines that the calculated electric capacity of the battery cell 110 is 100%, it may complete the charging of the battery cell 110.

The control unit 300 may check an electric capacity of the battery cell 110 through the charging and discharging channel 400 connected to the battery cell 110. The charging and discharging channel 400 serves as a path through which charging and discharging of the battery cell 110 are performed, and through this path, the control unit 300 may monitor an electrical state of the battery cell 110. That is, the control unit 300 may check the state of the battery cell 110 during a charging process or a discharging process of the battery cell 110 and collect data for efficient operation of the battery cell.

The control unit 300 may accurately calculate the electric capacity of the battery cell 110 through temperature correction. The control unit 300 may correct the electric capacity of the battery cell 110 by setting a representative temperature among temperatures measured through the temperature sensor 150. For example, the control unit 300 may divide a charging process or a discharging process of the battery cell 110 into at least one sub-section. The control unit 300 may set a representative temperature among the temperatures measured through the temperature sensor 150 for each of the at least one sub-section. Here, the temperature sensor 150 may measure the temperature a plurality of times within the at least one sub-section. The control unit 300 may then correct the electric capacity of the battery cell 110 based on the representative temperature.

The control unit 300 may set a representative temperature based on a difference between a corrected electric capacity according to each of the measured temperatures within at least one sub-section and an actual electric capacity of the battery cell. For example, the control unit 300 may calculate a corrected electric capacity based on the current, the target voltage, and the measured temperature. The control unit 300 may calculate a corrected electric capacity of the battery cell 110 according to each measured temperature during a charging process or a discharging process of the battery cell 110 through the charging and discharging channel 400, based on a calculated (or estimated) electric capacity of the battery cell 110 and the temperature measured through the temperature sensor 150. The control unit 300 may set the representative temperature according to a difference between the corrected electric capacity calculated for each measured temperature and an actual electric capacity of the battery cell 110 obtained through a reference performance test RPT.

Here, the representative temperature may be a reference temperature used for correcting the electric capacity in order to optimize battery performance by reflecting the influence of temperature variation of the battery cell on the electric capacity. That is, the control unit 300 may calculate a time point at which a difference between the corrected electric capacity and the actual electric capacity within at least one sub-section has a minimum value, and set a temperature at the corresponding time point as the representative temperature.

The control unit 300 may correct the electric capacity of the battery cell 110 based on the set representative temperature. For example, at a low temperature, a chemical reaction rate may decrease, thereby reducing the chargeable electric capacity of the battery cell 110. In contrast, at a high temperature, the chemical reaction rate may increase, thereby increasing the chargeable electric capacity of the battery cell 110. Accordingly, the control unit 300 may correct the electric capacity of the battery cell 110 according to the temperature and may set the representative temperature to perform a more accurate correction. The control unit 300 may set a representative temperature in at least one sub-section based on the corrected electric capacity according to each measured temperature and may correct the electric capacity of the battery cell 110 using the representative temperature.

The control unit 300 may update the representative temperature for each of the at least one sub-section. That is, the control unit 300 may update the representative temperature for each of the at least one sub-section and use the updated representative temperature to correct the electric capacity of the battery cell 110. Accordingly, the electric capacity of the battery cell 110 calculated by the control unit 300 may be corrected to more accurately reflect the actual electric capacity. The control unit 300 may charge or discharge the battery cell based on the corrected electric capacity calculated based on the representative temperature. Therefore, the charging and discharging apparatus can optimize the lifespan and performance of the battery cell by accurately calculating the electric capacity and performing charging or discharging based thereon.

The control unit 300 may control the blowing unit 200 for thermal management of the battery cell 110. The control unit 300 may manage heat generated from the battery cell 110 during charging or discharging through the blowing unit 200. The control unit 300 may individually control the blowing unit 200 based on a temperature measured through the temperature sensor 150.

The control unit 300 may receive a command from a user or control the input/output unit 510 that displays an operation state and an operation result. The input/output unit 510 may display a state of the charging and discharging apparatus 1000 on a screen or provide the result through sound or notification.

The control unit 300 may process various types of information and store the information in the memory unit 520. The control unit 300 may store in the memory unit 520 data such as the measured temperature, the representative temperature, the corrected electric capacity according to each measured temperature, and the actual electric capacity of the battery cell. For example, the control unit 300 may monitor in real time the voltage and current of the battery cell 110 according to temperature and collect data including the measured temperature, the representative temperature, and the corrected electric capacity corresponding to each temperature. The control unit 300 may then store the collected data in the memory unit 520 and use the stored data to accurately correct the electric capacity of the battery cell 110.

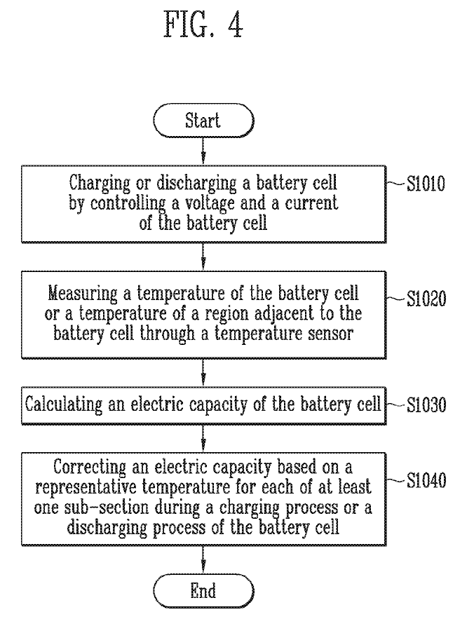

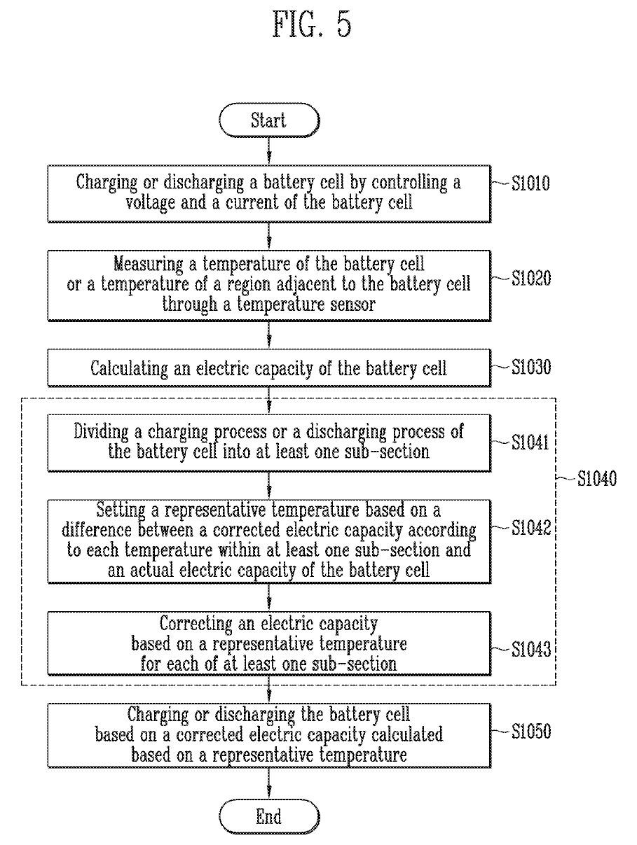

FIGS. 4 and 5 are flowcharts illustrating an example of a control method of the charging and discharging apparatus according to the present disclosure.

Referring to FIG. 4, a control method of a charging and discharging apparatus including a charging and discharging channel electrically connected to a battery cell 110 (see FIG. 2) and a jig 100 (see FIG. 2) supporting the battery cell 110 may include: a step S1010 of charging or discharging the battery cell; a step S1020 of measuring a temperature; a step S1030 of calculating an electric capacity of the battery cell; and a step S1040 of correcting the electric capacity based on a representative temperature.

In step S1010, the voltage and current of the battery cell may be controlled through the charging and discharging channel to charge or discharge the battery cell. The charging and discharging apparatus may fully charge or discharge the battery cell through the charging and discharging channel. In addition, the charging and discharging apparatus may charge or discharge the battery cell through the charging and discharging channel up to a preset target voltage or target electric capacity.

In step S1010, a current may be applied to the battery cell through the charging and discharging channel until the battery cell reaches a preset target voltage. During this process, the charging and discharging apparatus may control the voltage and current of the battery cell through the charging and discharging channel.

For example, during an initial charging process, the charging and discharging apparatus may control the system to apply a constant input current to increase the voltage of the battery cell. In the initial charging process, since the voltage of the battery cell is relatively low, the charging and discharging apparatus may charge the battery cell by applying a constant current. By charging the battery cell with a constant input current, the charging and discharging apparatus can protect the battery cell from damage caused by overcurrent and minimize stress applied to the battery cell, thereby extending the lifespan of the battery cell in the long term.

In another example, after the initial charging process, when the voltage of the battery cell reaches a preset reference voltage, the charging and discharging apparatus may control the system to apply a constant input voltage to increase the voltage of the battery cell. After the initial charging process, the charging and discharging apparatus may apply a constant voltage and gradually decrease the current to charge the battery cell until it is fully charged. By charging with a constant input voltage, the charging and discharging apparatus can prevent battery damage caused by overcharging and maintain stable chemical reactions inside the battery cell.

In step S1020, a temperature of the battery cell or a temperature of a region adjacent to the battery cell may be measured through a temperature sensor disposed at one side of the jig. In step S1020, the temperature may be measured a plurality of times within at least one sub-section.

The charging and discharging apparatus may measure a temperature change of the battery cell in real time. For example, during a charging process or a discharging process of the battery cell, the charging and discharging apparatus may measure the temperature a plurality of times within at least one sub-section corresponding to a section until the battery cell reaches a preset target voltage. The charging and discharging apparatus may measure a temperature of each region by arranging temperature sensors for each charging and discharging channel or for each jig. Through this, the charging and discharging apparatus may obtain a temperature of the battery cell or a region adjacent to the battery cell according to the progress of the process within at least one sub-section.

In step S1030, an electric capacity of the battery cell may be calculated. When the battery cell reaches a preset target voltage or target electric capacity, the charging and discharging apparatus may terminate the charging or discharging process. In this case, the charging and discharging apparatus may calculate the electric capacity during the charging process or the discharging process. The charging and discharging apparatus may then correct the calculated electric capacity using the measured temperature.

For example, the charging and discharging apparatus may calculate the electric capacity of the battery cell at a time point when the battery cell reaches a preset target voltage. The charging and discharging apparatus may calculate the electric capacity of the battery cell by using an amount of current and time until the voltage of the battery cell reaches the target voltage. The charging and discharging apparatus may then correct the calculated electric capacity by applying a preset temperature–capacity relationship or by using a temperature correction algorithm based on the measured temperature. However, this is merely an example, and the electric capacity of the battery cell 110 may be calculated by various known methods.

Although FIGS. 4 and 5 illustrate the steps S1010, S1020, and S1030 in sequence, the embodiments are not limited thereto. For example, the charging and discharging apparatus may simultaneously perform temperature measurement and electric capacity calculation while charging or discharging the battery cell.

In step S1040, the electric capacity may be corrected based on a representative temperature for each of at least one sub-section during a charging process or a discharging process of the battery cell. In step S1040, the charging process or discharging process of the battery cell may be divided into at least one sub-section. In step S1040, a representative temperature may be set among temperatures measured by the temperature sensor for each of the at least one sub-section, and the electric capacity may be corrected based on the representative temperature.

Referring to FIG. 5, the step S1040 of correcting the electric capacity based on a representative temperature may include a step S1041 of dividing a charging process or a discharging process of the battery cell into at least one sub-section, a step S1042 of setting a representative temperature among the measured temperatures, and a step S1043 of correcting the electric capacity based on the representative temperature for each of the at least one sub-section.

In step S1041, the charging process or the discharging process of the battery cell may be divided into at least one sub-section. For example, the charging and discharging apparatus may divide a section in which the battery cell is charged into a first sub-section in which the battery cell is charged with a constant input current and a second sub-section in which the battery cell is charged with a constant input voltage. In this case, the first sub-section may be a section in which a constant current is applied to increase the voltage of the battery cell up to a preset target voltage. In addition, the second sub-section may be a section in which a constant voltage is maintained and a gradually decreasing current is applied to fully charge the battery cell. However, the embodiments are not limited thereto. For example, a section in which the battery cell is charged with a constant input current or a section in which the battery cell is charged with a constant input voltage may each be divided into a plurality of sub-sections.

In step S1042, the representative temperature may be set based on a difference between a corrected electric capacity according to each temperature within at least one sub-section and an actual electric capacity of the battery cell. In step S1042, a time point at which a difference between the corrected electric capacity and the actual electric capacity within at least one sub-section has a minimum value may be calculated, and a temperature at the time point may be set as the representative temperature.

For example, the charging and discharging apparatus may correct the electric capacity according to each temperature measured tens, hundreds, or thousands of times within at least one sub-section. The charging and discharging apparatus may calculate a difference between the corrected electric capacity according to each measured temperature and the actual electric capacity at a constant temperature. The charging and discharging apparatus may calculate a time point at which the difference between the corrected electric capacity and the actual electric capacity has a minimum value by using RMSE (Root Mean Square Error), MAE (Mean Absolute Error), a weighted average, an arithmetic mean, or the like. The charging and discharging apparatus may then set the temperature corresponding to the calculated time point as the representative temperature of the at least one sub-section. However, the embodiments are not limited thereto, and the charging and discharging apparatus may employ various known statistical methods.

In step S1043, the electric capacity may be corrected based on the representative temperature for each of the at least one sub-section. For example, the charging and discharging apparatus may correct the electric capacity by applying a preset temperature–capacity relationship or by using a temperature correction algorithm, utilizing the representative temperature of the at least one sub-section instead of the measured temperature.

After the step S1040 of correcting the electric capacity based on the representative temperature, the method may further include a step S1050 of charging or discharging the battery cell according to the corrected electric capacity based on the representative temperature. By charging or discharging the battery cell according to the corrected electric capacity based on the representative temperature, the charging and discharging apparatus can manage the battery cell more efficiently and stably, and minimize performance degradation of the battery in the long term.

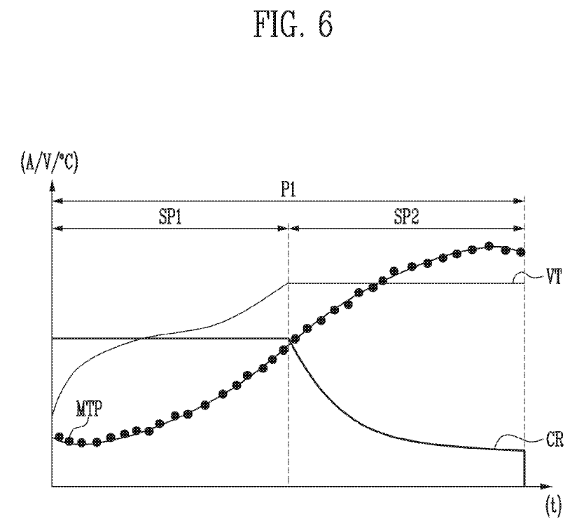

FIG. 6 is a view for explaining an example of measuring a temperature during a charging process of the charging and discharging apparatus according to the present disclosure.

Referring to FIGS. 3 and 6, the control unit 300 may divide a charging process or a discharging process of the battery cell into at least one sub-section SP1, SP2. The control unit 300 may collect multiple measured temperatures MTP in the at least one sub-section SP1, SP2 according to the progress of the process.

For example, in a charging process of a lithium polymer (LiPo) battery cell, the control unit 300 may divide a section P1 until the battery cell is fully charged into a first sub-section SP1 and a second sub-section SP2. Here, the first sub-section SP1 may be a constant current CC charging section in which the voltage VT of the battery cell increases from 3.0 V to 4.2 V. In addition, the second sub-section SP2 may be a constant voltage CV charging section in which the voltage VT of the battery cell remains constant at 4.2 V and the current CR decreases.

The control unit 300 may measure the temperature in real time during the charging process in each of the first sub-section SP1 and the second sub-section SP2 through the temperature sensor 150, and the measured temperatures MTP may be collected tens, hundreds, or thousands of times.

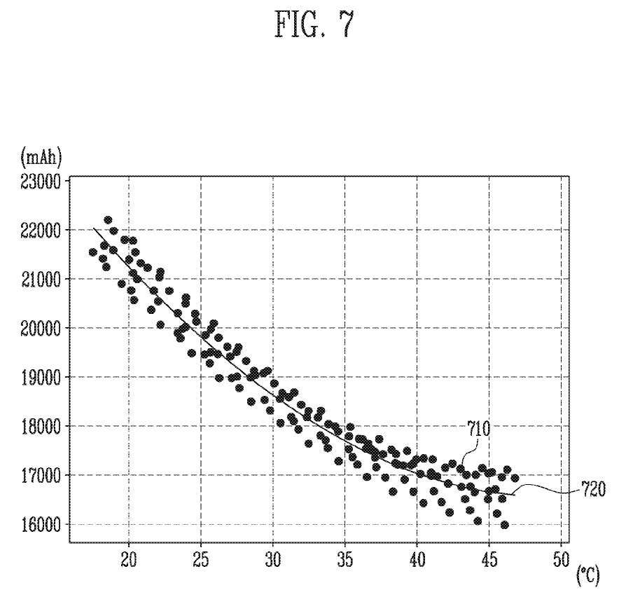

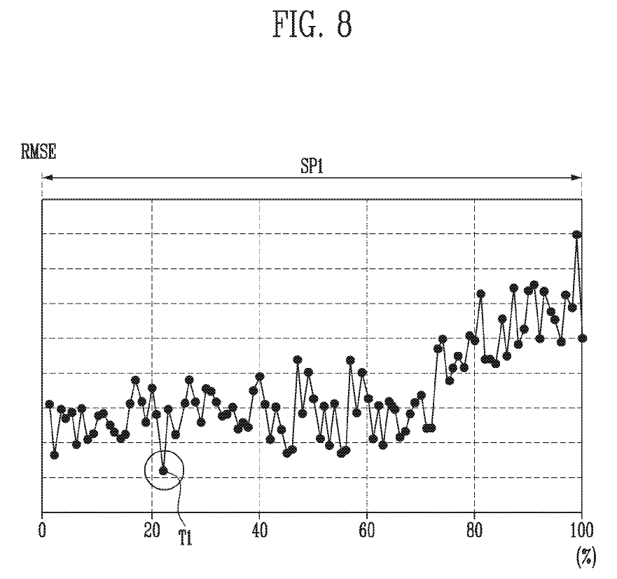

FIGS. 7 and 8 are views for explaining an example of setting a representative temperature during a process of calculating an electric capacity of the charging and discharging apparatus according to the present disclosure.

The control unit 300 may calculate a corrected electric capacity 710 according to each measured temperature MTP of the battery cell 110 and an actual electric capacity 720 obtained through a reference performance test.

Referring to FIG. 7, the control unit 300 may calculate the corrected electric capacity 710 at temperatures MTP measured tens, hundreds, or thousands of times. For example, the control unit 300 may calculate the corrected electric capacity 710 at each measured temperature MTP by using the amount of current, the time, and the measured temperature MTP until the voltage of the battery cell 110 reaches a target voltage. In addition, the control unit 300 may calculate the actual electric capacity 720 through a reference performance test conducted in a chamber in which the temperature is maintained constant by actual sampling.

The control unit 300 may calculate a time point T1 at which a difference between the corrected electric capacity 710 (see FIG. 7) and the actual electric capacity 720 (see FIG. 7) within at least one sub-section has a minimum value. The control unit 300 may calculate the time point T1 at which the difference between the corrected electric capacity 710 and the actual electric capacity 720 at the measured temperatures MTP has a minimum value by using RMSE (Root Mean Square Error), MAE (Mean Absolute Error), a weighted average, an arithmetic mean, or the like.

Referring to FIG. 8, the control unit 300 may divide the first sub-section SP1 according to a process progress rate (%) and calculate an average error between the corrected electric capacity 710 and the actual electric capacity 720 for each process progress rate (%). For example, the control unit 300 may calculate a difference value between the corrected electric capacity 710 and the actual electric capacity 720 for each process progress rate (%), square each difference value, and then calculate an average value. Thereafter, the control unit 300 may calculate an RMSE (Root Mean Square Error) as a square root of the average value.

Since a smaller RMSE indicates a higher similarity between the corrected electric capacity 710 and the actual electric capacity 720, the control unit 300 may determine that the corrected electric capacity 710 is accurate when the RMSE is small. The control unit 300 may calculate a time point T1 at which the RMSE has a minimum value when the process progress rate (%) of the first sub-section SP1 is approximately 22%. Accordingly, the control unit 300 may set the measured temperature MTP at the time point T1 where the RMSE has the minimum value as the representative temperature of the first sub-section SP1. Thereafter, the control unit 300 may correct the electric capacity in the first sub-section SP1 based on the set representative temperature instead of the measured temperature MTP.

The present disclosure may be embodied in various forms, and the scope of the present disclosure is not limited to the above-described embodiments. Therefore, it should be understood that any modified embodiment including the components of the claims of the present disclosure falls within the scope of the present disclosure.

What is claimed is:

1. A charging and discharging apparatus comprising:
a jig for supporting a battery cell;
a temperature sensor disposed at one side of the jig and configured to measure a temperature of the battery cell or a temperature of a region adjacent to the battery cell;
a charging and discharging channel electrically connected to the battery cell; and
a control unit configured to charge or discharge the battery cell by controlling a voltage and a current of the battery cell through the charging and discharging channel, and to calculate an electric capacity of the battery cell,
wherein the control unit is configured to divide a charging process or a discharging process of the battery cell into at least one sub-section, set a representative temperature among temperatures measured by the temperature sensor for each of the at least one sub-section, and correct the electric capacity based on the representative temperature.

2. The charging and discharging apparatus according to claim 1, wherein the control unit is configured to set the representative temperature based on a difference between a corrected electric capacity according to each of the measured temperatures within the at least one sub-section and an actual electric capacity of the battery cell.

3. The charging and discharging apparatus according to claim 2, wherein the control unit is configured to calculate a time point at which a difference between the corrected electric capacity and the actual electric capacity within the at least one sub-section has a minimum value, and to set a temperature at the time point as the representative temperature.

4. The charging and discharging apparatus according to claim 1, wherein the charging and discharging channel is configured to apply a current to the battery cell until the battery cell reaches a preset target voltage.

5. The charging and discharging apparatus according to claim 4, wherein the control unit is configured to control the current applied through the charging and discharging channel to have at least one of a preset constant input current and a preset constant input voltage.

6. The charging and discharging apparatus according to claim 4, wherein the control unit is configured to calculate the corrected electric capacity based on the current, the target voltage, and the measured temperature.

7. The charging and discharging apparatus according to claim 1, wherein the temperature sensor is configured to measure the temperature a plurality of times within the at least one sub-section.

8. The charging and discharging apparatus according to claim 1, wherein the control unit is configured to update the representative temperature for each of the at least one sub-section.

9. The charging and discharging apparatus according to claim 1, wherein the control unit is configured to charge or discharge the battery cell based on the corrected electric capacity calculated based on the representative temperature.

10. A control method of a charging and discharging apparatus including a charging and discharging channel electrically connected to a battery cell and a jig supporting the battery cell, the method comprising:
charging or discharging the battery cell by controlling a voltage and a current of the battery cell through the charging and discharging channel;
measuring a temperature of the battery cell or a temperature of a region adjacent to the battery cell through a temperature sensor disposed at one side of the jig;
calculating an electric capacity of the battery cell; and
correcting the electric capacity based on a representative temperature, wherein the representative temperature is set among temperatures measured by the temperature sensor for each of at least one sub-section obtained by dividing a charging process or a discharging process of the battery cell.

11. The control method of the charging and discharging apparatus according to claim 10, wherein correcting the electric capacity includes setting the representative temperature based on a difference between a corrected electric capacity according to each of the measured temperatures within the at least one sub-section and an actual electric capacity of the battery cell.

12. The control method of the charging and discharging apparatus according to claim 11, wherein correcting the electric capacity includes calculating a time point at which a difference between the corrected electric capacity and the actual electric capacity within the at least one sub-section has a minimum value, and setting a temperature at the time point as the representative temperature.

13. The control method of the charging and discharging apparatus according to claim 10, wherein charging or discharging the battery cell includes applying a current to the battery cell through the charging and discharging channel until the battery cell reaches a preset target voltage.

14. The control method of the charging and discharging apparatus according to claim 10, wherein measuring the temperature includes measuring the temperature a plurality of times within the at least one sub-section.

15. The control method of the charging and discharging apparatus according to claim 10, further comprising charging or discharging the battery cell according to the corrected electric capacity based on the representative temperature after correcting the electric capacity.
